(19) United States
(12) Patent Application Publication
(10) Pub. No.: US 2025/0379708 A1
(43) Pub. Date: Dec. 11, 2025

(54) BANDWIDTH BOOSTING FOR DOWNLINK & UPLINK TRANSMISSION

(71) Applicant: ZTE Corporation, Shenzhen (CN)

(72) Inventors: Xingguang WEI, Shenzhen (CN); Xianghui HAN, Shenzhen (CN); Bo DAI, Shenzhen (CN); Jing SHI, Shenzhen (CN)

(21) Appl. No.: 19/301,082

(22) Filed: Aug. 15, 2025

Related U.S. Application Data
(63) Continuation of application No. PCT/CN2023/085592, filed on Mar. 31, 2023.

(51) Int. Cl. H04L 5/00; H04W 72/0453

(52) U.S. Cl. CPC H04L 5/0064; H04W 72/0453

(57) ABSTRACT

A method for handling transmissions in a wireless cellular access network includes determining whether a switching period for memory switching is needed based on transmissions on transmission carriers. This provides a flexible mechanism for enabling memory switching to thereby boost the downlink (DL) and/or uplink (UL) bandwidth.

### CROSS-REFERENCE TO RELATED APPLICATION

This application is a continuation and claims priority to International Application No. PCT/CN2023/085592, filed on Mar. 31, 2023, the disclosure of which is hereby incorporated by reference herein in its entirety.

### TECHNICAL FIELD

This disclosure generally relates to handling transmissions in a wireless cellular access network and is specifically directed to a mechanism for boosting bandwidth for downlink (DL) and uplink (UL) transmissions.

### BACKGROUND

Based on the existing LTE and NR system, a user equipment (UE) (i.e., wireless terminal device) indicates the maximum supported bandwidth for each band or each carrier. Taking NR system as an example, the UE indicates the maximum supported bandwidth for each band/carrier to the base station (i.e., wireless access network node) via UE capability signaling such as channelBWs-DL, channelBWs-UL, supportedBandwidthCombinationSet and supportedBandwidthDL, and/or supportedBandwidthUL. The UE is not able to transmit UL transmission that occupy a bandwidth larger than its corresponding UE capability. Similarly, the UE is not able to receive DL transmission that occupy bandwidth larger than its corresponding UE capability. For example, if the UE indicates a maximum supported bandwidth for one band as 50 MHz for both DL and UL, then the UE is not able to transmit or receive transmissions that occupy a bandwidth larger than 50 MHz.

When the UE is configured with multiple carriers on multiple bands for DL or UL transmission, the UE capability regarding the supported bandwidth for each band is exclusive to each band and cannot be shared with other bands even if there is no transmission on that band. For example, if the UE indicates a maximum supported bandwidth as 50 MHz for DL for band A and band B, respectively, the UE can only receive DL transmission with up to 50 MHz bandwidth on band A even if there is no DL transmission on band B since the UE capability is exclusive to band A and band B. A new scheduling and configuration method is proposed to boost UE's DL/UL transmission bandwidth.

### SUMMARY

This disclosure relates to handling transmissions in a wireless cellular access network and is specifically directed to a mechanism for boosting bandwidth for downlink (DL) and uplink (UL) transmissions. The various example embodiments are particularly directed to determining whether a switching period for memory switching is needed to provide a flexible mechanism for enabling memory switching to thereby boost the UL and/or DL bandwidth.

In some exemplary implementations A method performed by a wireless terminal device for handling transmissions is disclosed, where the wireless terminal device is configured with P transmission carriers on a plurality of bands, where P is an integer and P is larger than 1. The method may include determining whether a switching period for memory switching is needed based on transmissions on the transmission carriers. In some embodiments, the P transmission carriers are P downlink (DL) transmission carriers, and the transmissions are downlink transmissions. The method may include determining that the switching period is needed in response to determining that the wireless terminal device is to receive any downlink transmission on a different band from a preceding downlink transmission. A DL nominal bandwidth and a DL boost bandwidth may be configured for each downlink carrier of each band, and the DL boost bandwidth may be larger than the DL nominal bandwidth, and the DL boost bandwidth may contain all Resource Elements (REs) or Resource Blocks (RBs) of the DL nominal bandwidth. The method may further include receiving downlink transmissions on at least two of the P downlink carriers simultaneously when each downlink transmission on each carrier occupies a frequency bandwidth no larger than the DL nominal bandwidth configured for each DL carrier.

In some exemplary implementations, which may be combined with any of the other exemplary implementations disclosed herein, the method also includes applying a prioritization rule to determine which downlink transmission to drop in response to there being more than one simultaneous downlink transmissions on more than one downlink carrier on more than one band, and at least one downlink transmission on one carrier on one band exceeding the DL nominal bandwidth for that downlink carrier. The prioritization rule may include at least one of the following: dropping a downlink transmission that exceeds the corresponding DL nominal bandwidth for the corresponding downlink carrier, and receiving other downlink transmissions that are not dropped; dropping a downlink transmission that does not exceed the corresponding DL nominal bandwidth for the corresponding downlink carrier, and receiving other downlink transmissions that are not dropped; dropping a downlink transmission on a carrier with a smaller carrier index, and receiving other downlink transmissions that are not dropped; receiving a downlink transmission on a carrier with a smaller carrier index, and dropping other downlink transmissions that are not received; dropping a downlink transmission that finishes or starts the latest, and receiving other downlink transmissions that are not dropped; and/or dropping a downlink transmission that finishes or starts the earliest, and receiving other downlink transmissions that are not dropped.

In some exemplary implementations, which may be combined with any of the other exemplary implementations disclosed herein, the method also includes the wireless terminal device receiving downlink transmission that is equal to or smaller than the DL boost bandwidth in case of bandwidth boosting. Also, the method may include applying, by the wireless terminal device, the DL nominal bandwidth in response to at least one of the following: a downlink transmission is scheduled on one downlink carrier that occupies frequency bandwidth not larger than the configured DL nominal bandwidth for the carrier; a downlink transmission on is scheduled on one downlink carrier that does not occupy a frequency resource outside the DL nominal bandwidth for the carrier; or simultaneous downlink transmissions are transmitted on more than one band. Similarly, the method may include applying, by the wireless terminal device, the DL boost bandwidth in response to at least one of the following: a downlink transmission is scheduled on one downlink carrier that occupies frequency bandwidth larger than the configured DL nominal bandwidth for the carrier; a downlink transmission is scheduled on one downlink carrier that occupies frequency resource outside the DL nominal bandwidth for the carrier; or simultaneous downlink transmissions are transmitted on only one band.

In some exemplary implementations, which may be combined with any of the other exemplary implementations disclosed herein, the method also includes the wireless terminal device determining that the switching period is needed in response to determining that the wireless terminal device is to receive a downlink transmission on one downlink carrier on one band and the downlink transmission occupies a frequency bandwidth larger than the configured DL nominal bandwidth, and in response to a preceding downlink transmission being on another downlink carrier on another band. Alternatively, the method may include determining that the switching period is needed in response to determining that the wireless terminal device is to receive a downlink transmission on one downlink carrier on one band and the downlink transmission occupies a frequency resource outside the DL nominal bandwidth, and in response to a preceding downlink transmission being on another downlink carrier on another band. Alternatively, the method may include determining that the switching period is needed in response to determining that the wireless terminal device is to receive a downlink transmission on one downlink carrier on one band and a preceding downlink transmission is on another downlink carrier on another band, and the preceding downlink transmission occupies a frequency bandwidth larger than the configured DL nominal bandwidth. Alternatively, the method may include determining that the switching period is needed in response to determining that the wireless terminal device is to receive a downlink transmission on one downlink carrier on one band and a preceding downlink transmission is on another downlink carrier on another band, and the preceding downlink transmission occupies a frequency resource outside the DL nominal bandwidth. Alternatively, the method may include determining that the switching period is needed in response to determining that the wireless terminal device is to receive a downlink transmission on one downlink carrier on one band and the downlink transmission occupies frequency bandwidth larger than the configured DL nominal bandwidth, and a preceding downlink transmission is on a downlink carrier on the same band and the wireless terminal device is under an operation state in which downlink transmission occupying frequency bandwidth larger than the configured DL nominal bandwidth cannot be supported in the same band. Alternatively, the method may include determining that the switching period is needed in response to determining that the wireless terminal device is to receive a downlink transmission on one downlink carrier on one band and the downlink transmission occupies a frequency resource outside the DL nominal bandwidth, and a preceding downlink transmission is on a downlink carrier on the same band and the wireless terminal device is under an operation state in which downlink transmission occupying frequency resources outside the DL nominal bandwidth cannot be supported in the same band. Alternatively, the method may include determining that the switching period is needed in response to determining that the wireless terminal device is to receive a downlink transmission on one downlink carrier on one band, and a preceding downlink transmission is on another downlink carrier on another band and the wireless terminal device is under an operation state in which downlink transmission occupying a frequency bandwidth larger than the configured DL nominal bandwidth can be supported in the same other band. Alternatively, the method may include determining that the switching period is needed in response to determining that the wireless terminal device is to receive a downlink transmission on one downlink carrier on one band, and a preceding downlink transmission is on another downlink carrier on another band and the wireless terminal device is under an operation state in which downlink transmission occupying a frequency resource outside the DL nominal bandwidth can be supported in the same other band.

In some exemplary implementations, each of the P downlink carriers is configured with a DL nominal bandwidth, and each of the DL nominal bandwidths configured for the P downlink carriers contains Nᵢ Resource Elements (Res) or Resource Blocks (RBs) in frequency domain, where Nᵢ is an integer larger than 0, and i is an index of downlink carriers, where 1≤i≤P, wherein the wireless terminal device is configured with a total bandwidth for the P downlink carriers containing M REs or RBs in frequency domain, wherein M is an integer larger than 0. M may satisfy the following conditions:

$$M \geq {N}_{i} , 1 \leq i \leq P , and$$

$$M \leq {\sum }_{i = 1}^{P} {N}_{i} .$$

In some exemplary implementations, which may be combined with any of the other exemplary implementations disclosed herein, the method also includes the wireless terminal device receiving downlink transmissions on multiple carriers on multiple bands simultaneously when a sum of bandwidth of the downlink transmissions does not exceed the configured total bandwidth. The method may include applying a prioritization rule to determine which downlink transmission to drop in response to there being more than one simultaneous downlink transmissions on more than one downlink carrier on more than one band, and a sum of bandwidth of the downlink transmissions exceeds the configured total bandwidth. The prioritization rule may include at least one of the following: dropping a downlink transmission on a carrier with a smaller carrier index, and receiving other downlink transmissions that are not dropped; receiving a downlink transmission on a carrier with a smaller carrier index, and dropping other downlink transmissions that are not received; dropping a downlink transmission that finishes or starts the latest, and receiving other downlink transmissions that are not dropped; dropping a downlink transmission that finishes or starts the earliest, and receiving other downlink transmissions that are not dropped; and/or dropping a downlink transmission with a smaller priority, and receiving other downlink transmissions that are not dropped, wherein priority is configured for each carrier or for each band.

The method may include triggering memory switching during the switching period. During the switching period, at least one of the following may be satisfied: the wireless terminal device is not expected to receive any downlink transmissions; the wireless terminal device drops downlink transmission on bands involved in the memory switching; or a wireless access network node avoids scheduling downlink transmission that is to be transmitted during the switching period. The switching period allows for memory switching of a first memory allocated for transmissions on a first band of the P transmission carriers to being allocated for transmissions on a second band of the P transmission carriers.

The method may further include indicating, by the wireless terminal device, a DL RF bandwidth to a wireless access network node, wherein the wireless access network node configures downlink carriers to the wireless terminal device if a frequency range from a lowest frequency among all the configured downlink carriers to a highest frequency among all the configured downlink carriers is not larger than the DL RF bandwidth indicated by the wireless terminal device. Additionally, at least one of a Synchronization Signal Block (SSB), a Primary Synchronization Signal (PSS), a Secondary Synchronization Signal (SSS), a Physical Broadcast Channel (PBCH), and/or a Physical Downlink Control Channel (PDCCH) may be contained within the DL nominal bandwidth.

In some exemplary implementations, the P transmission carriers are P uplink (UL) transmission carriers, and the transmissions are uplink transmissions. The method may also include the wireless terminal device determining that the switching period is needed in response to determining that the wireless terminal device is to transmit any uplink transmission on a different band from a preceding uplink transmission. A UL nominal bandwidth and a UL boost bandwidth may be configured for each uplink carrier of each band. The UL boost bandwidth may be larger than the UL nominal bandwidth, and the UL boost bandwidth may contain all Resource Elements (REs) or Resource Blocks (RBs) of the UL nominal bandwidth. The method may further include transmitting uplink transmissions on at least two of the P UL carriers simultaneously when each UL transmission on each UL carrier occupies a frequency bandwidth no larger than the UL nominal bandwidth configured for each UL carrier.

In some exemplary implementations, which may be combined with any of the other exemplary implementations disclosed herein, the method also includes the wireless terminal device applying a prioritization rule to determine which UL transmission to drop in response to there being more than one simultaneous UL transmissions on more than one UL carrier on more than one band, and at least one UL transmission on one carrier on one band exceeding the UL nominal bandwidth for that UL carrier. The prioritization rule may include at least one of the following: dropping a UL transmission that exceeds the corresponding UL nominal bandwidth for the corresponding UL carrier, and transmitting other UL transmissions that are not dropped; dropping a UL transmission that does not exceed the corresponding UL nominal bandwidth for the corresponding UL carrier, and transmitting other UL transmissions that are not dropped; dropping a UL transmission on a carrier with a smaller carrier index, and transmitting other UL transmissions that are not dropped; transmitting a UL transmission on a carrier with a smaller carrier index, and dropping other UL transmissions that are not transmitted; dropping a UL transmission that finishes or starts the latest, and transmitting other UL transmissions that are not dropped; and/or dropping a UL transmission that finishes or starts the earliest, and transmitting other UL transmissions that are not dropped.

In some exemplary implementations, which may be combined with any of the other exemplary implementations disclosed herein, the method also includes the wireless terminal device transmitting UL transmission that is equal to or smaller than the UL boost bandwidth in case of bandwidth boosting. The method may also include applying, by the wireless terminal device, the UL nominal bandwidth in response to at least one of the following: a UL transmission is scheduled on one UL carrier that occupies frequency bandwidth not larger than the configured UL nominal bandwidth for the carrier; a UL transmission is scheduled on one UL carrier that does not occupy a frequency resource outside the UL nominal bandwidth for the carrier; or simultaneous UL transmissions are transmitted on more than one band. The method may also include applying, by the wireless terminal device, the UL boost bandwidth in response to at least one of the following: a UL transmission is scheduled on one UL carrier that occupies frequency bandwidth larger than the configured UL nominal bandwidth for the carrier; a UL transmission is scheduled on one UL carrier that occupies frequency resource outside the UL nominal bandwidth for the carrier; or simultaneous UL transmissions are transmitted on only one band. The method may also include applying UL hopping using the UL boost bandwidth.

In some exemplary implementations, which may be combined with any of the other exemplary implementations disclosed herein, the method also includes the wireless terminal device determining that the switching period is needed in response to determining that the wireless terminal device is to transmit a UL transmission on one UL carrier on one band and the UL transmission occupies a frequency bandwidth larger than the configured UL nominal bandwidth, and in response to a preceding UL transmission being on another UL carrier on another band. Alternatively, the method may include determining that the switching period is needed in response to determining that the wireless terminal device is to transmit a UL transmission on one UL carrier on one band and the UL transmission occupies a frequency resource outside the UL nominal bandwidth, and in response to a preceding UL transmission being on another UL carrier on another band. Alternatively, the method may include determining that the switching period is needed in response to determining that the wireless terminal device is to transmit a UL transmission on one UL carrier on one band and a preceding UL transmission is on another UL carrier on another band, and the preceding UL transmission occupies a frequency bandwidth larger than the configured UL nominal bandwidth.

Alternatively, the method may include determining that the switching period is needed in response to determining that the wireless terminal device is to transmit a UL transmission on one UL carrier on one band and a preceding UL transmission is on another UL carrier on another band, and the preceding UL transmission occupies a frequency resource outside the UL nominal bandwidth. Alternatively, the method may include determining that the switching period is needed in response to determining that the wireless terminal device is to transmit a UL transmission on one UL carrier on one band and the UL transmission occupies frequency bandwidth larger than the configured UL nominal bandwidth, and a preceding UL transmission is on a UL carrier on the same band and the wireless terminal device is under an operation state in which UL transmission occupying frequency bandwidth larger than the configured UL nominal bandwidth cannot be supported in the same band. Alternatively, the method may include determining that the switching period is needed in response to determining that the wireless terminal device is to transmit a UL transmission on one UL carrier on one band and the UL transmission occupies a frequency resource outside the UL nominal bandwidth, and a preceding UL transmission is on a UL carrier on the same band and the wireless terminal device is under an operation state in which UL transmission occupying frequency resources outside the UL nominal bandwidth cannot be supported in the same band. Alternatively, the method may include determining that the switching period is needed in response to determining that the wireless terminal device is to transmit a UL transmission on one UL carrier on one band, and a preceding UL transmission is on another UL carrier on another band and the wireless terminal device is under an operation state in which UL transmission occupying a frequency bandwidth larger than the configured UL nominal bandwidth can be supported in the same other band. Alternatively, the method may include determining that the switching period is needed in response to determining that the wireless terminal device is to transmit a UL transmission on one UL carrier on one band, and a preceding UL transmission is on another UL carrier on another band and the wireless terminal device is under an operation state in which UL transmission occupying a frequency resource outside the UL nominal bandwidth can be supported in the same other band.

In some exemplary implementations, each of the P UL carriers is configured with a UL nominal bandwidth, and each of the UL nominal bandwidths configured for the P UL carriers contains Nᵢ Resource Elements (Res) or Resource Blocks (RBs) in frequency domain, where Nᵢ is an integer larger than 0, and i is an index of UL carriers, where 1≤i≤P, wherein the wireless terminal device is configured with a total bandwidth for the P UL carriers containing M REs or RBs in frequency domain, wherein M is an integer larger than 0. M may satisfy the following conditions:

$$M \geq {N}_{i} , 1 \leq i \leq P , and$$

$$M \leq {\sum }_{i = 1}^{P} {N}_{i} .$$

The method may further include transmitting, by the wireless terminal device, UL transmissions on multiple carriers on multiple bands simultaneously when a sum of bandwidth of the UL transmissions does not exceed the configured total bandwidth. The method may also include applying a prioritization rule to determine which UL transmission to drop in response to there being more than one simultaneous UL transmissions on more than one UL carrier on more than one band, and a sum of bandwidth of the UL transmissions exceeds the configured total bandwidth. The prioritization rule may include at least one of the following: dropping a UL transmission on a carrier with a smaller carrier index, and transmitting other UL transmissions that are not dropped; transmitting a UL transmission on a carrier with a smaller carrier index, and dropping other UL transmissions that are not transmitted; dropping a UL transmission that finishes or starts the latest, and transmitting other UL transmissions that are not dropped; dropping a UL transmission that finishes or starts the earliest, and transmitting other UL transmissions that are not dropped; and/or dropping a UL transmission with a smaller priority, and transmitting other UL transmissions that are not dropped, wherein priority is configured for each carrier or for each band.

The method may further include triggering memory switching during the switching period. During the switching period, at least one of the following may be satisfied: the wireless terminal device is not expected to transmit any UL transmissions; the wireless terminal device drops UL transmission on bands involved in the memory switching; or a wireless access network node avoids scheduling UL transmission that is to be transmitted during the switching period. The switching period may allow for memory switching of a first memory allocated for transmissions on a first band of the P transmission carriers to being allocated for transmissions on a second band of the P transmission carriers. The method may include indicating, by the wireless terminal device, a UL RF bandwidth to a wireless access network node, wherein the wireless access network node configures UL carriers to the wireless terminal device if a frequency range from a lowest frequency among all the configured UL carriers to a highest frequency among all the configured UL carriers is not larger than the UL RF bandwidth indicated by the wireless terminal device. In certain embodiments, at least one of a Physical Random Access Channel (PRACH) and/or a Physical Uplink Control Channel (PUCCH) are contained within the UL nominal bandwidth.

In another embodiment, a method performed by a wireless access network node for handling transmissions, includes receiving, from a wireless terminal device, transmission bandwidth information of the wireless access network node, and configuring transmission carriers to the wireless terminal device in accordance with the transmission bandwidth information. The method may also include receiving, from the wireless terminal device, a DL RF bandwidth to a wireless access network node as the transmission bandwidth information, and configuring, by the wireless access network node, downlink carriers to the wireless terminal device if a frequency range from a lowest frequency among all the configured downlink carriers to a highest frequency among all the configured downlink carriers is not larger than the DL RF bandwidth indicated by the wireless terminal device. Similarly, the method may include receiving, from the wireless terminal device, a UL RF bandwidth to a wireless access network node as the transmission bandwidth information, and configuring, by the wireless access network node, UL carriers to the wireless terminal device if a frequency range from a lowest frequency among all the configured UL carriers to a highest frequency among all the configured UL carriers is not larger than the UL RF bandwidth indicated by the wireless terminal device. The method may include avoiding scheduling UL transmission that is to be transmitted during a switching period, and/or avoiding scheduling DL transmission that is to be transmitted during a switching period.

In some exemplary implementations, which may be combined with any of the other exemplary implementations disclosed herein, the method also includes the wireless access network node receiving, from the wireless terminal device, a UL nominal bandwidth and a UL boost bandwidth to a wireless access network node as the transmission bandwidth information, configuring, by the wireless access network node, UL nominal bandwidth for a UL carrier that is not larger than the UL nominal bandwidth, and configuring, by the wireless access network node, UL boost bandwidth for a UL carrier that is not larger than the UL boost bandwidth. The method may also include receiving, from the wireless terminal device, a DL nominal bandwidth and a DL boost bandwidth to a wireless access network node as the transmission bandwidth information, configuring, by the wireless access network node, DL nominal bandwidth for a DL carrier that is not larger than the DL nominal bandwidth, and configuring, by the wireless access network node, DL boost bandwidth for a DL carrier that is not larger than the DL boost bandwidth. The method may also include receiving, from the wireless terminal device, a UL nominal bandwidth for each UL carrier and a UL total bandwidth as the transmission bandwidth information, configuring, by the wireless access network node UL nominal bandwidth for a UL carrier that is not larger than the UL nominal bandwidth, and configuring, by the wireless access network node, UL total bandwidth for the wireless terminal device that is not larger than the UL total bandwidth. The method may also include receiving, from the wireless terminal device, a DL nominal bandwidth for each DL carrier and a DL total bandwidth as the transmission bandwidth information, configuring, by the wireless access network node DL nominal bandwidth for a DL carrier that is not larger than the DL nominal bandwidth, and configuring, by the wireless access network node, DL total bandwidth for the wireless terminal device that is not larger than the DL total bandwidth.

In some other implementations, an apparatus for wireless communication such as a network device is disclosed. The network device main include one or more processors and one or more memories, wherein the one or more processors are configured to read computer code from the one or more memories to implement any one of the methods above. The apparatus for wireless communication may be the wireless access node or the wireless terminal device.

In yet some other implementations, a computer program product is disclosed. The computer program product may include a non-transitory computer-readable medium with computer code stored thereupon, the computer code, when executed by one or more processors, causing the one or more processors to implement any one of the methods above.

The above embodiments and other aspects and alternatives of their implementations are explained in greater detail in the drawings, the descriptions, and the claims below.

### BRIEF DESCRIPTION OF THE DRAWINGS

FIG. 1 shows a wireless access network with an exemplary uplink, downlink, and control channel configuration.

FIG. 2 shows various example processing components of the wireless terminal device and the wireless access network node of FIG. 1.

FIG. 3A is a block diagram illustrating a legacy design of memory and RF filters in multiple bands.

FIG. 3B is a block diagram illustrating the aspect of memory sharing in accordance with various embodiments.

FIG. 4 is a timing diagram illustrating aspects of various embodiments.

FIG. 5 is another timing diagram illustrating aspects of various embodiments.

FIG. 6 is a diagram illustrating relative bandwidths.

FIG. 7 is another timing diagram illustrating aspects of various embodiments.

FIG. 8 is another timing diagram illustrating aspects of various embodiments.

FIG. 9 is another timing diagram illustrating aspects of various embodiments.

### DETAILED DESCRIPTION

The technology and examples of implementations and/or embodiments described in this disclosure can be used to facilitate over-the-air radio resource allocation, configuration, and signaling in wireless access networks as well as operational configuration of a UE and/or a base station within the wireless access networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed to handling transmissions in a wireless cellular access network and is specifically directed to a mechanism for boosting bandwidth for downlink (DL) and uplink (UL) transmissions. The various example embodiments provide configurations and signaling to enable a UE to determine whether a switching period for memory switching is needed. In this manner, memory switching can be effected, particularly during the switching period, to thereby boost the UL and/or DL bandwidth. As a result, DL and/or UL throughput can be increased in a cost-effective and efficient manner.

### Wireless Network Overview

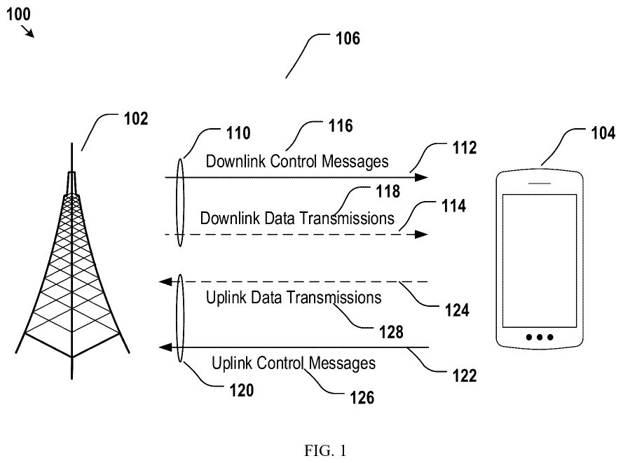

A wireless communication network may include a radio access network for providing network access to wireless terminal devices, and a core network for routing data between the access networks or between the wireless network and other types of data networks. In a wireless access network, radio resources are provided for allocation and used for transmitting data and control information. FIG. 1 shows an exemplary wireless access network 100 including a wireless access network node (WANN) or wireless base station 102 (herein referred to as wireless base station, base station, wireless access node, wireless access network node, or WANN) and a wireless terminal device or user equipment (UE) 104 (herein referred to as user equipment, UE, terminal device, or wireless terminal device) that communicates with one another via over-the-air (OTA) radio communication resources 106. The wireless access network 100 may be implemented as, as for example, a 2G, 3G, 4G/LTE, or 5G cellular radio access network. Correspondingly, the base station 102 may be implemented as a 2G base station, a 3G node B, an LTE eNB, or a 5G New Radio (NR) gNB. The user equipment 104 may be implemented as mobile or fixed communication devices installed with mobile identity modules for accessing the base station 102. The user equipment 104 may include but is not limited to mobile phones, laptop computers, tablets, personal digital assistants, wearable devices, distributed remote sensor devices, and desktop computers. Alternatively, the wireless access network 100 may be implemented as other types of radio access networks, such as Wi-Fi, Bluetooth, ZigBee, and WiMax networks.

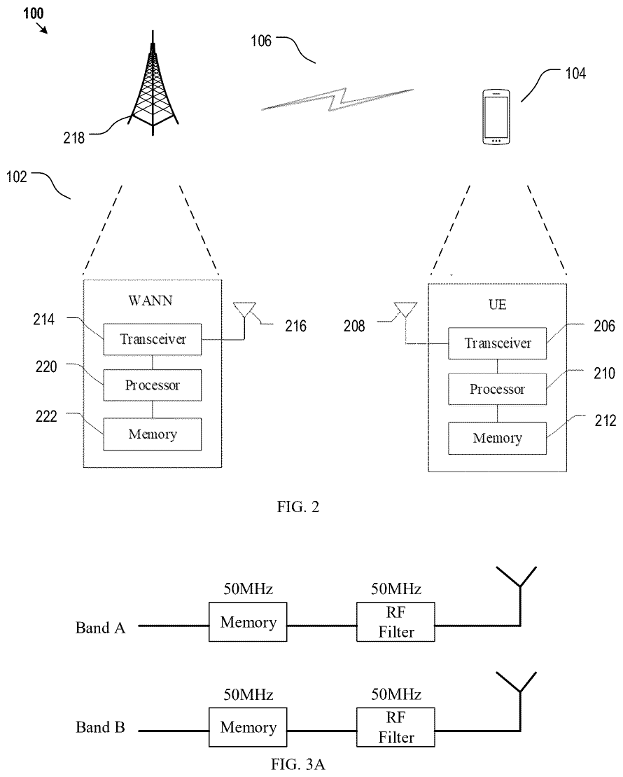

FIG. 2 further shows example processing components of the WANN 102 and the UE 104 of FIG. 1. The UE 104, for example, may include transceiver circuitry 206 coupled to one or more antennas 208 to effectuate wireless communication with the WANN 102 (or to other UEs). The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the, functions, methods, and processes of the UE 104 described herein. The memory 212 may also be utilized and allocated for buffering UL and DL transmissions in each band/carrier. The memory 212 may include multiple memory modules assigned to different functions (such as program memory, base band memory, and/or RF memory, to name a few). Likewise, the WANN 102 may include transceiver circuitry 214 coupled to one or more antennas 216, which may include an antenna tower 218 in various forms, to effectuate wireless communications with the UE 104. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions, methods, and processes of the WANN 102 described herein.

### Wireless Communication Resource Scheduling/Signaling

Returning to FIG. 1, the radio communication resources for the over-the-air interface 106 may include a combination of frequency, time, and/or spatial communication resources organized into various resource units or elements in frequency, time, and/or space. The radio communication resources 106 in frequency domain may include portions of licensed radio frequency bands, portions of unlicensed ration frequency bands, or portions of a mix of both licensed and unlicensed radio frequency bands. The radio communication resources 106 available for carrying the wireless communication signals between the base station 102 and user equipment 104 may be further divided into physical downlink channels 110 for transmitting wireless signals from the base station 102 to the user equipment 104 and physical uplink channels 120 for transmitting wireless signals from the user equipment 104 to the base station 102. The physical downlink channels 110 may further include physical downlink control channels (PDCCHs) 112 and physical downlink shared channels (PDSCHs) 114. Likewise, the physical uplink channels 120 may further include physical uplink control channels (PUCCHs) 122 and physical uplink shared channels (PUSCHs) 124. For simplification, other types of downlink and uplink channels are not shown in FIG. 1 but are within the scope of the current disclosure. The control channels PDCCHs 112 and PUCCHs 122 may be used for carrying control information in the form of control messages 116 and 126, herein referred to as Downlink Control Information (DCI) messages or Uplink Control Information (UCI) messages. The shared channels (shared between data and control information) PDSCHs 114 and PUSCHs 124 may be allocated and used for communicating downlink data transmissions 118 and uplink data transmissions 128 between the base station 102 and the user equipment 104.

The allocation and configuration of the radio communication resources associated with the data channels, such as the PDSCHs and the PUSCHs may be provided by one or more resource scheduling DCIs carried in the PDCCHs. The PDCCHs may be shared by a plurality of UEs in the access network. In various approaches, a particular UE may be configured to perform blind decode procedures on a preconfigured UE-specific Search Space (USS) to detect and identify a payload of a resource scheduling DCI carried in the PDCCH that specifically targets the particular UE. The blind decoding may be performed on preconfigured monitoring occasions of the PDCCH associated with USS. Such monitoring occasions may be referred to as a set of PDCCH candidates. Each PDCCH candidate may be associated with a set of Control Channel Elements (CCEs). The UE may specifically use its Radio Network Temporary Identifier (RNTI) to decode the PDCCH candidates. The RNTI may be used to demask a PDCCH candidate's CRC. If no CRC error is detected, the UE determines that PDCCH candidate carries its own control information. The UE may then process the DCI and extract the resource allocation information pertaining to the PDSCH and/or PUSCH for receiving and/or transmitting data.

### Memory Switching to Boost DL/UL Bandwidth

The maximum supported bandwidth for one band/carrier is restricted by the RF filter bandwidth and memory. The memory (which may be a portion or a module of the memory 212 of the UE 104) can include different storage medium for base band processing (base band memory) or RF processing (RF memory). The RF filter bandwidth is typically fixed and cannot be shared among bands. However, in accordance with various embodiments herein, the memory can be shared among bands.

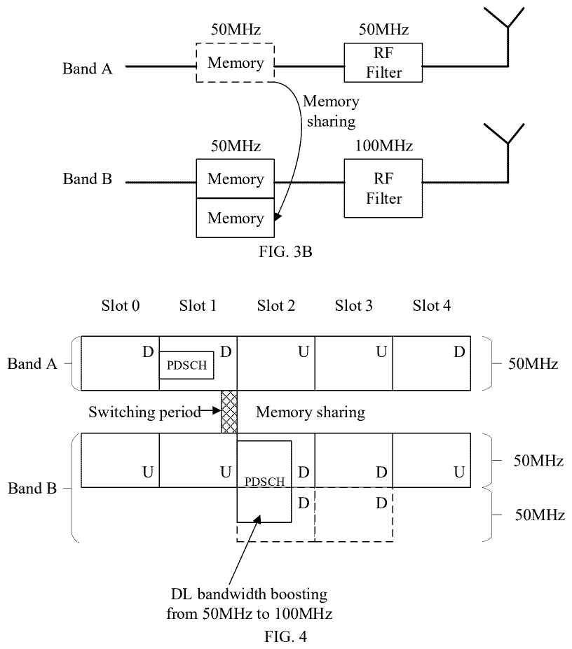

With reference to FIGS. 3A and 3B as an example, in FIG. 3A, a legacy UE's maximum bandwidth for DL transmission is 50 MHz, for example, for band A and band B, respectively. Thus, in this example, for each of band A and band B, the UE is equipped with an RF filter for 50 MHz bandwidth and is equipped with sufficient memory for 50 MHz bandwidth. However, in FIG. 3B, if the UE supports memory sharing between band A and band B, band A and band B are still equipped with sufficient memory for 50 MHz bandwidth, respectively. However, the UE's memory for band A can be shared with band B. In this example, the UE's memory for band B is sufficient for DL and/or UL transmissions up to 100 MHz bandwidth. As such, if the RF filter bandwidth for band B is updated to 100 MHz, the UE can support DL and/or UL transmissions with up to 100 MHz bandwidth. With memory sharing among bands, the UE is able to boost its DL and/or UL transmission bandwidth to 100 MHz in this example.

As a result of such memory switching, the bandwidth can be boosted. Bandwidth boosting allows the UE to utilize its memory resources and bandwidth resources in a flexible manner according to the traffic load, TDD slot configuration, channel state, etc., which leads to higher throughput. For example, in FIG. 3A, if the channel state of band A is poor or if band A is unavailable for DL and/or UL transmission in some slots due to TDD slot configuration, UE can only receive DL transmission and/or transmit UL transmissions with up to 50 MHz (for example) bandwidth on band B. However, as is shown in FIG. 3B, if the UE supports memory switching to boost DL and/or UL bandwidth, the UE can borrow the memory from band A to band B and receive DL transmission and/or transmit UL transmissions with up to 100 MHz (for example) bandwidth on band B. In this case, DL and/or UL throughput can be boosted.

Similarly, memory switching is a cost effective means to increase bandwidth. Without bandwidth boosting, in order to support DL and/or UL transmission with up to 100 MHz (for example) bandwidth on band B, UE needs to be equipped with RF filter for 100 MHz bandwidth and be equipped with sufficient memory for 100 MHz bandwidth. With bandwidth boosting, as shown in FIG. 3B, the UE only needs to be equipped with RF filter for 100 MHz bandwidth, but can be equipped with sufficient memory for 50 MHz (for example) bandwidth on each band. As such, the cost of the memory for band B is reduced for the UE, thereby reducing the overall cost to produce the UE.

As is discussed in further detail below, a switching period may be needed by the UE for memory sharing to boost the bandwidth. For example, in FIG. 3B, a switching period is required for the UE to perform memory switch from band A to band B. In various embodiments, during the switching period, the UE may not be able to perform DL and/or UL transmission depending on the UE capability.

### Description of New Memory Switching Mechanism

As mentioned above, in accordance with the present disclosure, a method is disclosed to enable a UE to determine whether a switching period for memory switching is needed. In some examples, some UEs may not be able to share partial memory between bands. Instead, the UE may only be able to share the entire memory from one band to another band. In order to allow for such complete memory sharing across bands, one solution is to avoid simultaneous transmission on these two bands. Once there is transmission on one band, in accordance with various embodiments, all of the memory for that band and the band that shares its memory is allocated for the transmission on that band to boost bandwidth for UL or DL transmissions.

In accordance with various embodiments, a method performed by the wireless terminal device or UE 104 for handling transmissions is disclosed. As part of this method, the UE 104 may be configured with P transmission carriers on a plurality of bands, where P is an integer and P is larger than 1. The method may further comprise the UE 104 determining whether a switching period for memory switching is needed based on transmissions on the transmission carriers. The switching period allows for memory switching of a first memory allocated for transmissions on a first band of the P transmission carriers to being allocated for transmissions on a second band of the P transmission carriers.

In a DL scenario, if the UE 104 is to receive any downlink transmission (say upcoming downlink transmission) on a different band from a preceding downlink transmission, a switching period may be needed. Memory switching is triggered during the switching period. During the switching period, the UE 104 switches its memory from the band for the preceding downlink transmission to the band for the upcoming downlink transmission. In this way, the memory is shared from one band to another. In various embodiments, as illustrated in FIG. 4, the UE 104 may require some time to switch the memory, for example, due to technological limitations of the UE or the memory. In various embodiments, the switching period may be anywhere from 10 us to 500 us (microseconds), depending on the capabilities of the UE 104 and its components, though other times are contemplated. In various embodiments, the UE 104 will indicate its capabilities to the base station 102 so that the base station 102 knows the length of the switching period it should use.

During the switching period, at least one of the following is satisfied: (1) the UE 104 is not expected to receive any downlink transmissions; (2) the UE 104 drops downlink transmission on bands involved in the memory switching; and/or (3) a wireless access network node 102 avoids scheduling downlink transmission that is to be transmitted during the switching period.

Once the memory is switched to the band for the upcoming downlink transmission, the bandwidth for the upcoming downlink transmission can be boosted in frequency domain. The downlink transmission can be downlink channel or downlink signal, e.g., PDCCH (Physical Downlink Control Channel), PDSCH (Physical Downlink Shared Channel), CSI-RS (Channel State Information Reference Signal), DM-RS (Demodulation Reference Signals), SSB (Synchronization Signal Block) and other downlink channels or signals. The band can be any band type, e.g., TDD band, FDD band, SDL band, licensed band, unlicensed band, side link band, full duplex band, etc.

Turning to FIG. 4 as an example, for band A, slot 0, slot 1, slot 2, slot 3, and slot 4 are configured for downlink, downlink, uplink, uplink, and downlink transmission, respectively. For band B, slot 0, slot 1, slot 2, slot 3, and slot 4 are configured for uplink, uplink, downlink, downlink, and uplink transmission, respectively. ‘D’ and ‘U’ in FIG. 4 refer to downlink and uplink, respectively. The UE 104 is equipped with memory for 50 MHz bandwidth for band A and band B, respectively, in this example. The UE 104 supports memory sharing from band A to band B, i.e., the UE 104 supports switching its memory from band A to band B. The UE 104 may indicate its UE capability to a base station 102 to indicate its maximum DL bandwidth is 50 MHz and 100 MHz for band A and band B, respectively. In slot 1, the UE receives PDSCH transmission on band A and UE 104 can only receive downlink transmission that occupies frequency resource no larger than 50 MHz (i.e., bandwidth for the downlink transmission is restricted to 50 MHz). In slot 2, the UE 104 receives PDSCH transmission on band B and UE can receive downlink transmission that occupies frequency resource larger than 50 MHz but no larger than 100 MHz since the memory has been switched from band A to band B (i.e., bandwidth for the downlink transmission is restricted to 100 MHz on band B). In this example, the PDSCH transmission on band A in slot 1 is the preceding downlink transmission and PDSCH transmission on band B in slot 2 is the upcoming downlink transmission.

In an UL scenario, if the UE 104 is to transmit any uplink transmission on a different band from the preceding uplink transmission, a switching period may be needed. Memory switching is triggered during the switching period. During the switching period, the UE 104 switches its memory from the band for the preceding uplink transmission to the band for the upcoming uplink transmission. As discussed above, this memory switching requires time, and as such, a switching period may be utilized.

During this memory switching period, at least one of the following is satisfied: (1) the UE 104 is not expected to transmit any UL transmissions; (2) the UE 104 drops UL transmission on bands involved in the memory switching; and/or (3) a wireless access network node 102 avoids scheduling a UL transmission that is to be transmitted during the switching period.

Once the memory is switched to the band for the upcoming uplink transmission, the bandwidth for the upcoming uplink transmission can be boosted. The uplink transmission can be uplink channel or uplink signal, e.g., PUCCH (Physical Uplink Control Channel), PUSCH (Physical Uplink Shared Channel), SRS (Sounding Reference Signal), PRACH (Physical Random Access Channel) and other uplink channels or signals. The band can be any band type, e.g., TDD band, FDD band, SUL band, licensed band, unlicensed band, side link band, full duplex band, etc.

Turning to FIG. 5 as an example, for band A, slot 0, slot 1, slot 2, slot 3, and slot 4 are configured for downlink, downlink, uplink, uplink, and downlink transmission, respectively. For band B, slot 0, slot 1, slot 2, slot 3, and slot 4 are configured for uplink, uplink, downlink, downlink, and uplink transmission, respectively. ‘D’ and ‘U’ in FIG. 5 refer to downlink and uplink, respectively. The UE 104 is equipped with memory for 50 MHz bandwidth for band A and band B, respectively. The UE 104 may indicate its UE capability to the base station 102 to indicate its maximum UL bandwidth is 100 MHz and 50 MHz for band A and band B, respectively. The UE 104 supports memory sharing from band B to band A, i.e., the UE 104 supports switching its memory from band B to band A. In slot 1, the UE 104 transmits PUSCH transmission on band B and the UE 104 can only transmit transmission that occupies frequency resource no larger than 50 MHz (i.e., bandwidth for the uplink transmission is restricted to 50 MHz). In slot 2, the UE 104 transmits PUSCH transmission on band A and the UE 104 can transmit uplink transmission that is larger than 50 MHz but not larger than 100 MHz since the memory has been switched from band B to band A (i.e., bandwidth for the uplink transmission is restricted to 100 MHz for band A). In this example, the PUSCH transmission on band B in slot 1 is the preceding uplink transmission and the PUSCH transmission on band A in slot 2 is the upcoming uplink transmission.

In accordance with the various embodiments, all of the transmissions (UL or DL) need to be transmitted within the maximum frequency bandwidth associated with the corresponding band. Take band n34 as an example, the UL frequency resource and DL frequency resource for band n34 is 2010 MHz-2025 MHz. The maximum UL and DL frequency bandwidth for band n34 is 15 MHz. In other words, the all the transmissions have to be transmitted within 15 MHz. With reference to FIG. 4 as an example, the maximum frequency bandwidth associated with band B is equal to 100 MHz. Thus, in this example, even if bandwidth boosting is supported via memory sharing, the transmission still has to be transmitted within the maximum bandwidth associated with the band B (e.g., 100 MHz).

Although the above example embodiments only discuss memory switching from one band to another band, memory switching can also be bi-directional in various embodiments. For example, memory can switch from band A to band B to boost DL/UL bandwidth on band B, and memory can also switch from band B to band A to boost DL/UL bandwidth on band A.

Similarly, although the above example embodiments only discuss memory switching between two bands, memory can also switch among more than two bands. For example, among band combination {band A, band B, band C}, memory can be switched from band A to band B, from band A to band C, from band B to band C, from band C to band A, and from band C to band B.

In various embodiments, if the memory can be switched from band A to band B, but the memory dedicated for band B cannot be switched from band B to band A, bandwidth can be boosted on band B but not on band A. In other words, band B can “borrow” the memory from band A and give it back to band A, but band A cannot “borrow” the memory from band B. Conversely, if the memory can be switched from band A to band B and the memory dedicated for band B can be switched from band B to band A, bandwidth can be boosted on band A and band B. In other words, band B can “borrow” the memory from band A and give it back to band A, and band A can “borrow” the memory from band B and give it back to band B.

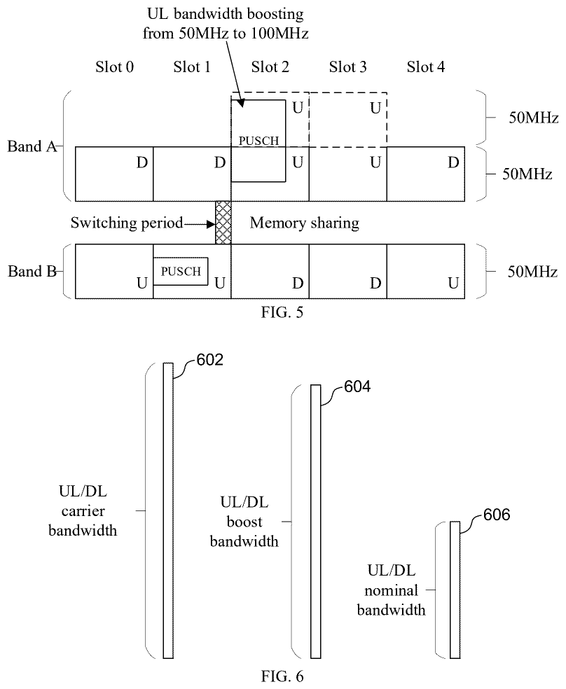

In accordance with various embodiments, in an uplink scenario, a UL nominal bandwidth and a UL boost bandwidth are configured for each uplink carrier of each band for the UE 104. The UL nominal bandwidth may include a number of REs (Resource Elements) or RBs (Resource Blocks) in frequency domain on the uplink carrier. The UL boost bandwidth may include a number of REs or RBs in frequency domain on the uplink carrier. FIG. 6 depicts the relationship between UL carrier bandwidth 602, UL boost bandwidth 604, and UL nominal bandwidth 606. As is illustrated in FIG. 6, the UL boost bandwidth 604 is larger than the UL nominal bandwidth 606. The UL boost bandwidth 604 contains all the REs or RBs of the UL nominal bandwidth 606. As is also shown in FIG. 6, the UL boost bandwidth 604 is fully contained within the UL carrier bandwidth 602.

In certain embodiments, the UE 104 may indicate the UL nominal bandwidth and UL boost bandwidth to the base station 102. The base station 102 may configure the UL nominal bandwidth for the uplink carrier that is not larger than the UL nominal bandwidth indicated by the UE 104. The base station 102 also may configure the UL boost bandwidth for the uplink carrier that is not larger than the UL boost bandwidth indicated by the UE 104.

If the UE 104 is configured with an UL nominal bandwidth for P uplink carriers, respectively (where P is an integer larger than 1), the UE 104 can transmit uplink transmissions on these P uplink carriers simultaneously as long as each uplink transmission on each carrier occupies a frequency bandwidth no larger than the configured nominal bandwidth for each carrier. A method may include the UE 104 transmitting uplink transmissions on at least two of the P UL carriers simultaneously as long as and/or when each UL transmission on each UL carrier occupies a frequency bandwidth no larger than the UL nominal bandwidth configured for each UL carrier. In this example, the P transmission carriers are P uplink (UL) transmission carriers, and the transmissions are uplink transmissions.

In case there are more than one simultaneous uplink transmissions on more than one uplink carrier on more than one bands, and at least one uplink transmission on one carrier on one band exceeds the UL nominal bandwidth for that uplink carrier, a prioritization rule is applied to determine which uplink transmission is dropped. The prioritization rule includes at least one of the following:
Alternative 1: Dropping a UL transmission that exceeds the corresponding UL nominal bandwidth for the corresponding UL carrier, and transmitting other UL transmissions that are not dropped.
Alternative 2: Dropping a UL transmission that does not exceed the corresponding UL nominal bandwidth for the corresponding UL carrier, and transmitting other UL transmissions that are not dropped.
Alternative 3: Dropping a UL transmission on a carrier with a smaller carrier index, and transmitting other UL transmissions that are not dropped.
Alternative 4: Transmitting a UL transmission on a carrier with a smaller carrier index, and dropping other UL transmissions that are not transmitted.
Alternative 5: Dropping a UL transmission that finishes or starts the latest, and transmitting other UL transmissions that are not dropped.
Alternative 6: Dropping a UL transmission that finishes or starts the earliest, and transmitting other UL transmissions that are not dropped.

These alternatives may be used individually or together. For example, for Alternatives 5 and 6, these can be combined with other alternatives above, for example, if the transmission started or ended at same time, can use one of the other alternatives as a secondary decision when determining which transmission to drop.

Alternative 1 prioritizes the UL transmission that doesn't exceed the UL nominal bandwidth. Alternative 2 prioritizes the UL transmission that exceeds the UL nominal bandwidth. Alternative 3 and Alternative 4 are implementation friendly since the prioritization rule is semi-statically fixed based on the carrier index. Alternative 5 and Alternative 6 try to prioritize the transmission based on the starting or ending time, which can be aligned with UE's processing pipeline.

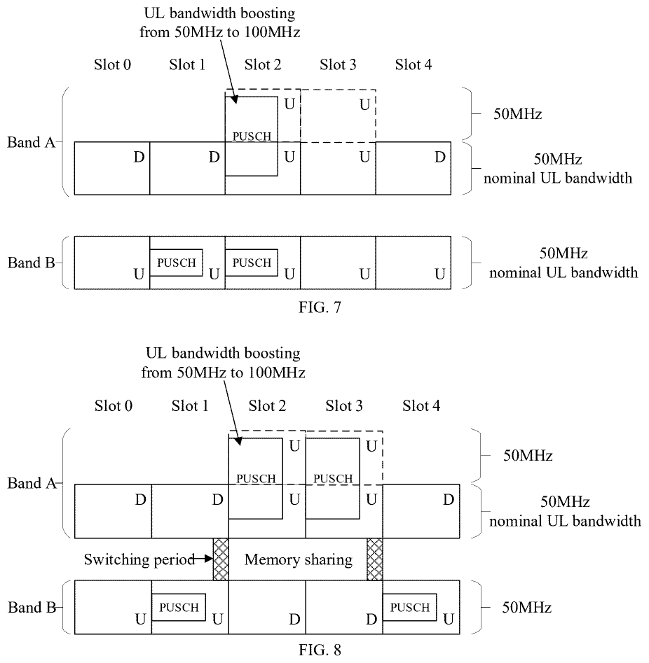

Turning to FIG. 7 as an example, for band A, slot 0, slot 1, slot 2, slot 3, and slot 4 are configured for downlink, downlink, uplink, uplink, and downlink transmission, respectively. Band B is an FDD band and only the uplink carrier is depicted in this figure. Thus, slot 0, slot 1, slot 2, slot 3, and slot 4 are all configured for uplink. ‘D’ and ‘U’ in FIG. 7 refer to downlink and uplink, respectively. The UE 104 is equipped with memory for 50 MHz bandwidth for band A and band B, respectively, in this example. The UE 104 may indicate its UE capability to the base station 102 to indicate its UL nominal bandwidth is 50 MHz for band A and band B, respectively, and indicates its UL boost bandwidth is 100 MHz for band A. The UE 104 supports memory sharing from band B to band A, i.e., the UE 104 supports switching its memory from band B to band A. Thus, the nominal UL bandwidth for band A is configured as 50 MHz and the boost bandwidth for band A is configured as 100 MHz in this example.

In slot 1, the UE 104 transmits PUSCH transmission on band B and the UE 104 can only transmit transmission that is not larger than 50 MHz. In slot 2, two uplink transmissions are triggered, i.e., one is PUSCH transmission on band A that occupies bandwidth larger than the corresponding UL nominal bandwidth, another is the PUSCH transmission on band B that occupies bandwidth smaller than the corresponding UL nominal bandwidth. If Alternative 1 above is applied, the PUSCH transmission on band A is dropped and UE transmits PUSCH on band B. If Alternative 2 above is applied, the PUSCH transmission on band B is dropped and UE transmits PUSCH on band A.

For bandwidth boosting, the UE 104 can transmit uplink transmission on one carrier on one band that is equal to or smaller than the UL boost bandwidth configured for the carrier.

In accordance with various embodiments, the UE 104 applies the UL nominal bandwidth if at least one of the following happens:

The uplink transmission is scheduled on one uplink carrier that occupies frequency bandwidth not larger than the configured nominal bandwidth for the carrier;

The uplink transmission is scheduled on one uplink carrier that does not occupy a frequency resource outside the nominal bandwidth for the carrier; or

Simultaneous uplink transmissions are transmitted on more than band.

In accordance with various embodiments, the UE 104 applies the UL boost bandwidth if at least one of the following happens:
The uplink transmission scheduled on one uplink carrier that occupies frequency bandwidth larger than the configured nominal bandwidth for the carrier;
The uplink transmission scheduled on one uplink carrier that occupies frequency resource outside the nominal bandwidth for the carrier; or
The simultaneous uplink transmission(s) is transmitted on only one band. In other words, there is no other overlapping uplink transmission on other bands.

In accordance with some embodiments, once the boost bandwidth is applied, uplink hopping also may occur within the boost bandwidth.

In accordance with various embodiments, memory switching is triggered in a switching period at least for one of the following examples. In other words, the UE 104 determines that a switching period is needed for at least one of the following examples.

In one example, when the UE 104 is to transmit an uplink transmission on one uplink carrier on one band, and the uplink transmission occupies frequency bandwidth larger than the configured nominal bandwidth, and if the preceding uplink transmission is on another uplink carrier on another band, a switching period is needed. Memory switching is triggered during the switching period.

In another example, when the UE 104 is to transmit an uplink transmission on one uplink carrier on one band, and the uplink transmission occupies frequency resource outside the nominal bandwidth, and if the preceding uplink transmission is on another uplink carrier on another band, a switching period is needed. Memory switching is triggered during the switching period.

In another example, when the UE 104 is to transmit an uplink transmission on one uplink carrier on one band, and if the preceding uplink transmission is on another uplink carrier on another band, and the preceding uplink transmission occupies frequency bandwidth larger than the configured nominal bandwidth, a switching period is needed. Memory switching is triggered during the switching period.

In another example, when the UE 104 is to transmit an uplink transmission on one uplink carrier on one band, and if the preceding uplink transmission is on another uplink carrier on another band, and the preceding uplink transmission occupies frequency resource outside the nominal bandwidth, a switching period is needed. Memory switching is triggered during the switching period.

In another example, when the UE 104 is to transmit an uplink transmission on one uplink carrier on one band, and the uplink transmission occupies frequency bandwidth larger than the configured nominal bandwidth, and if the preceding uplink transmission is on an uplink carrier on the same band, and the UE is under the operation state in which uplink transmission occupying frequency bandwidth larger than the configured nominal bandwidth cannot be supported in that same band (e.g., because memory is not currently being shared between the bands), a switching period is needed. Memory switching is triggered during the switching period.

In another example, when the UE 104 is to transmit an uplink transmission on one uplink carrier on one band, and the uplink transmission occupies frequency resource outside the nominal bandwidth, and if the preceding uplink transmission is on an uplink carrier on the same band, and the UE 104 is under the operation state in which uplink transmission occupying frequency resource outside the nominal bandwidth cannot be supported in the same band (e.g., because memory is not currently being shared between the bands), a switching period is needed. Memory switching is triggered during the switching period.

In another example, when the UE 104 is to transmit an uplink transmission on one uplink carrier on one band, and if the preceding uplink transmission is on another uplink carrier on another band, and the UE is under the operation state in which uplink transmission occupying frequency bandwidth larger than the configured nominal bandwidth can be supported in the same other band (e.g., because memory is currently being shared to the other band, for example, to facilitate a boosted bandwidth on that other band in the preceding transmission), a switching period is needed (e.g., to return the memory back to the one uplink carrier). Memory switching is triggered during the switching period.

In another example, when the UE 104 is to transmit an uplink transmission on one uplink carrier on one band, and if the preceding uplink transmission is on another uplink carrier on another band, and the UE is under the operation state in which uplink transmission occupying frequency resource outside the nominal bandwidth can be supported in the same other band (e.g., because memory is currently being shared to the other band, for example, to facilitate a boosted bandwidth on that other band in the preceding transmission), a switching period is needed (e.g., to return the memory back to the one uplink carrier). Memory switching is triggered during the switching period.

Turning to FIG. 8 as an example, for band A, slot 0, slot 1, slot 2, slot 3, and slot 4 are configured for downlink, downlink, uplink, uplink, and downlink transmission, respectively. For band B, slot 0, slot 1, slot 2, slot 3, and slot 4 are configured for uplink, uplink, downlink, downlink, and uplink transmission, respectively. ‘D’ and ‘U’ in FIG. 8 refer to downlink and uplink, respectively. The UE 104 is equipped with memory for 50 MHz bandwidth for band A and band B, respectively, in this example. The UE 104 supports memory sharing from band B to band A, i.e., the UE 104 supports switching its memory from band B to band A. Thus, the nominal UL bandwidth for band A is configured as 50 MHz and the boost bandwidth for band A is configured as 100 MHz in this example.

In this example, in slot 1, a preceding PUSCH transmission is transmitted on band B. In slot 2, the UE 104 is to transmit a PUSCH transmission that occupies frequency bandwidth larger than the configured nominal bandwidth, or is to transmit a PUSCH transmission that occupies frequency resource outside the nominal bandwidth. As such, a switching period is required between these two PUSCH transmissions for the UE 104 to perform memory switching from band B to band A.

In slot 3, a preceding PUSCH transmission that occupies frequency bandwidth larger than the configured nominal bandwidth, or a PUSCH transmission that occupies frequency resource outside the nominal bandwidth, is transmitted on band A. In slot 4, the UE 104 is to transmit a PUSCH transmission on band B. In this case, a switching period is required between these two PUSCH transmissions for the UE 104 to perform memory switching from band A back to band B.

Although the preceding embodiment has been discussed above in the context of an uplink scenario, the embodiment also applies similarly (though with slight differences) in a downlink scenario, as described below.

In accordance with various embodiments, in a downlink scenario, a DL nominal bandwidth and a DL boost bandwidth are configured for each downlink carrier of each band for the UE 104. The DL nominal bandwidth may include a number of REs or RBs in frequency domain on the downlink carrier. The DL boost bandwidth may include a number of REs or RBs in frequency domain on the downlink carrier. As is shown in FIG. 6, the DL boost bandwidth 604 is larger than the DL nominal bandwidth 606. The DL boost bandwidth 604 contains all the REs or RBs of the DL nominal bandwidth 606. The DL boost bandwidth 604 is fully contained within the DL carrier bandwidth 602.

In certain embodiments, the UE 104 may indicate the DL nominal bandwidth and DL boost bandwidth to the base station 102. The base station 102 may configure the DL nominal bandwidth for the downlink carrier that is not larger than the DL nominal bandwidth indicated by the UE 104. The base station 102 also may configure the DL boost bandwidth for the downlink carrier that is not larger than the DL boost bandwidth indicated by the UE 104.

If the UE 104 is configured with a DL nominal bandwidth for P downlink carriers, respectively (where P is an integer larger than 1), the UE 104 can receive downlink transmissions on these P downlink carriers simultaneously as long as each downlink transmission on each carrier occupies frequency bandwidth no larger than the configured nominal bandwidth for each carrier. A method may include the UE 104 receiving downlink transmissions on at least two of the P downlink carriers simultaneously as long as and/or when each downlink transmission on each carrier occupies a frequency bandwidth no larger than the DL nominal bandwidth configured for each DL carrier. In this example, the P transmission carriers are P downlink (DL) transmission carriers, and the transmissions are downlink transmissions.

In case there are more than one simultaneous downlink transmissions on more than one downlink carriers on more than one bands, and at least one downlink transmission on one carrier on one band exceeds the DL nominal bandwidth for that downlink carrier, a prioritization rule is applied to determine which downlink transmission is dropped. The prioritization rule for DL transmissions is similar to the prioritization rule discussed above for UL transmissions, and includes at least one of the following:
Alternative 1: Dropping a downlink transmission that exceeds the corresponding DL nominal bandwidth for the corresponding downlink carrier, and receiving other downlink transmissions that are not dropped.
Alternative 2: Dropping a downlink transmission that does not exceed the corresponding DL nominal bandwidth for the corresponding downlink carrier, and receiving other downlink transmissions that are not dropped.
Alternative 3: Dropping a downlink transmission on a carrier with a smaller carrier index, and receiving other downlink transmissions that are not dropped.
Alternative 4: Receiving a downlink transmission on a carrier with a smaller carrier index, and dropping other downlink transmissions that are not received.
Alternative 5: Dropping a downlink transmission that finishes or starts the latest, and receiving other downlink transmissions that are not dropped.
Alternative 6: Dropping a downlink transmission that finishes or starts the earliest, and receiving other downlink transmissions that are not dropped.
   These alternatives may be used individually or together.

Alternative 1 prioritizes the DL transmission that does not exceed the DL nominal bandwidth. Alternative 2 prioritizes the DL transmission that exceeds the DL nominal bandwidth. Alternative 3 and Alternative 4 are implementation friendly since the prioritization rule is semi-statically fixed based on the carrier index. Alternative 5 and Alternative 6 try to prioritize the transmission based on the starting or ending time, which can be aligned with UE's processing pipeline.

For bandwidth boosting, the UE 104 can receive DL transmission on one carrier on one band that is equal to or smaller than the DL boost bandwidth configured for the carrier.

In accordance with various embodiments, the UE 104 applies the DL nominal bandwidth if at least one of the following happens:
The downlink transmission is scheduled on one downlink carrier that occupies frequency bandwidth not larger than the configured nominal bandwidth for the carrier;
The downlink transmission is scheduled on one downlink carrier that does not occupy a frequency resource outside the nominal bandwidth for the carrier; or
Simultaneous downlink transmissions are transmitted on more than band.

In accordance with various embodiments, the UE 104 applies the DL boost bandwidth if at least one of the following happens:
The downlink transmission scheduled on one downlink carrier that occupies frequency bandwidth larger than the configured nominal bandwidth for the carrier;
The downlink transmission scheduled on one downlink carrier that occupies frequency resource outside the nominal bandwidth for the carrier; or
The simultaneous downlink transmission(s) is transmitted on only one band. In other words, there is no other overlapping downlink transmission on other bands.

In accordance with various embodiments, memory switching is triggered in a switching period at least for one of the following examples. In other words, the UE 104 determines that a switching period is needed for at least one of the following examples.

In one example, when the UE 104 is to receive a downlink transmission on one downlink carrier on one band, and the downlink transmission occupies frequency bandwidth larger than the configured nominal bandwidth, and if the preceding downlink transmission is on another downlink carrier on another band, a switching period is needed. Memory switching is triggered during the switching period.

In another example, when the UE 104 is to receive a downlink transmission on one downlink carrier on one band, and the downlink transmission occupies frequency resource outside the nominal bandwidth, and if the preceding downlink transmission is on another downlink carrier on another band, a switching period is needed. Memory switching is triggered during the switching period.

In another example, when the UE 104 is to receive a downlink transmission on one downlink carrier on one band, and if the preceding downlink transmission is on another downlink carrier on another band, and the preceding downlink transmission occupies frequency bandwidth larger than the configured nominal bandwidth, a switching period is needed. Memory switching is triggered during the switching period.

In another example, when the UE 104 is to receive a downlink transmission on one downlink carrier on one band, and if the preceding downlink transmission is on another downlink carrier on another band, and the preceding downlink transmission occupies frequency resource outside the nominal bandwidth, a switching period is needed. Memory switching is triggered during the switching period.

In another example, when the UE 104 is to receive a downlink transmission on one downlink carrier on one band, and the downlink transmission occupies frequency bandwidth larger than the configured nominal bandwidth, and if the preceding downlink transmission is on an downlink carrier on the same band, and the UE is under the operation state in which downlink transmission occupying frequency bandwidth larger than the configured nominal bandwidth cannot be supported in that same band (e.g., because memory is not currently being shared between the bands), a switching period is needed. Memory switching is triggered during the switching period.

In another example, when the UE 104 is to receive a downlink transmission on one downlink carrier on one band, and the downlink transmission occupies frequency resource outside the nominal bandwidth, and if the preceding downlink transmission is on a downlink carrier on the same band, and the UE 104 is under the operation state in which downlink transmission occupying frequency resource outside the nominal bandwidth cannot be supported in the same band (e.g., because memory is not currently being shared between the bands), a switching period is needed. Memory switching is triggered during the switching period.

In another example, when the UE 104 is to receive a downlink transmission on one downlink carrier on one band, and if the preceding downlink transmission is on another downlink carrier on another band, and the UE is under the operation state in which downlink transmission occupying frequency bandwidth larger than the configured nominal bandwidth can be supported in the same other band (e.g., because memory is currently being shared to the other band, for example, to facilitate a boosted bandwidth on that other band in the preceding transmission), a switching period is needed (e.g., to return the memory back to the one downlink carrier). Memory switching is triggered during the switching period.

In another example, when the UE 104 is to receive a downlink transmission on one downlink carrier on one band, and if the preceding downlink transmission is on another downlink carrier on another band, and the UE is under the operation state in which downlink transmission occupying frequency resource outside the nominal bandwidth can be supported in the same other band (e.g., because memory is currently being shared to the other band, for example, to facilitate a boosted bandwidth on that other band in the preceding transmission), a switching period is needed (e.g., to return the memory back to the one downlink carrier). Memory switching is triggered during the switching period.

During this memory switching period, at least one of the following is satisfied: (1) the UE 104 is not expected to receive any DL transmissions; (2) the UE 104 drops DL transmission on bands involved in the memory switching; and/or (3) a wireless access network node 102 avoids scheduling a DL transmission that is to be transmitted during the switching period.

In accordance with various embodiments, in case the UE 104 is able to perform memory sharing among bands flexibly, the UE 104 can switch its memory among bands as long as the total scheduled transmission bandwidth at each symbol doesn't exceed the UE capability of the total bandwidth.

In an uplink scenario, the UE 104 may be configured with P uplink carriers. Each of the P uplink carriers is configured with an UL nominal bandwidth. Each of the UL nominal bandwidths configured for the P uplink carriers contains Nᵢ REs or RBs in frequency domain, where Nᵢ is an integer larger than 0, and i is the index of uplink carriers, i.e., 1≤i≤P. The UE 104 may be configured with a total bandwidth for the P uplink carriers. The total bandwidth contains M REs or RBs in frequency domain, where M is an integer larger than 0. M satisfies the following conditions:

$$M \geq {N}_{i} , 1 \leq i \leq P$$

$$M \leq {\sum }_{i = 1}^{P} {N}_{i}$$

The UE 104 can transmit uplink transmission that is equal to or smaller than the nominal UL bandwidth on one carrier on one band. The UE 104 can transmit uplink transmissions on multiple carriers on multiple bands simultaneously if the sum of bandwidth of the scheduled uplink transmissions does not exceed the configured total bandwidth.

In case there are more than one simultaneous uplink transmissions on more than one uplink carriers on more than one bands, and the sum of bandwidth of the scheduled uplink transmissions exceeds the configured total bandwidth, a prioritization rule is applied to determine which uplink transmission is dropped. This prioritization rule is similar to the prioritization rule discussed above for UL transmissions when there are more than one simultaneous uplink transmissions on more than one uplink carrier on more than one bands and at least one uplink transmission on one carrier on one band exceeds the UL nominal bandwidth for that uplink carrier. Alternatives 1-4 below are the same as Alternatives 3-6 discussed above. A fifth alternative is added. The prioritization rule includes at least one of the following:
Alternative 1: Dropping a downlink transmission on a carrier with a smaller carrier index, and receiving other downlink transmissions that are not dropped.
Alternative 2: Receiving a downlink transmission on a carrier with a smaller carrier index, and dropping other downlink transmissions that are not received.
Alternative 3: Dropping a downlink transmission that finishes or starts the latest, and receiving other downlink transmissions that are not dropped.
Alternative 4: Dropping a downlink transmission that finishes or starts the earliest, and receiving other downlink transmissions that are not dropped.
Alternative 5: Dropping a UL transmission with a smaller priority, and transmitting other UL transmissions that are not dropped, wherein priority is configured for each carrier or for each band. This alternative allows for flexible configuration of priorities among different carriers.

The UE 104 may indicate the UL nominal bandwidth for each UL carrier and the total bandwidth to the base station 102. The base station 102 may configure the UL nominal bandwidth for the uplink carrier that is not larger than the UL nominal bandwidth indicated by the UE 104. The base station 102 may configure the UL total bandwidth for the UE 104 that is not larger than the UL total bandwidth indicated by the UE 104.

Similarly, in a downlink scenario, the UE 104 may be configured with P downlink carriers. Each of the P downlink carriers is configured with a DL nominal bandwidth. Each of the DL nominal bandwidths configured for the P downlink carriers contains Nᵢ REs or RBs in frequency domain, where Nᵢ is an integer larger than 0, and i is the index of downlink carriers, i.e., 1≤i≤P. The UE 104 may be configured with a total bandwidth for the P downlink carriers. The total bandwidth contains M REs or RBs in frequency domain, where M is an integer larger than 0. M satisfies the following conditions:

$$M \geq {N}_{i} , 1 \leq i \leq P$$

$$M \leq {\sum }_{i = 1}^{P} {N}_{i}$$

The UE 104 can receive downlink transmission that is equal to or smaller than the nominal DL bandwidth on one carrier on one band. The UE 104 can receive downlink transmissions on multiple carriers on multiple bands simultaneously if the sum of bandwidth of the scheduled downlink transmissions does not exceed the configured total bandwidth.

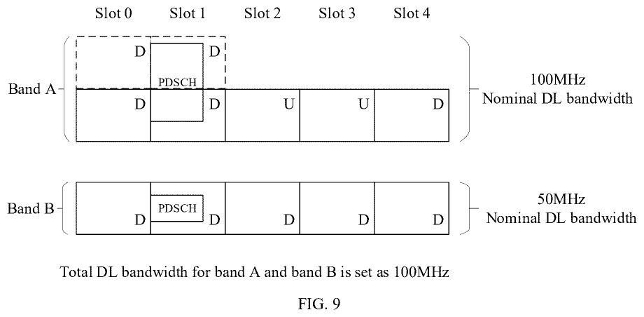

Turning to FIG. 9 as an example, for band A, slot 0, slot 1, slot 2, slot 3, and slot 4 are configured for downlink, downlink, uplink, uplink, and downlink transmission, respectively. ‘D’ and ‘U’ in the figure refer to downlink and uplink, respectively. Band B is an FDD band and only the downlink carrier is depicted in this figure. Thus, slot 0, slot 1, slot 2, slot 3, and slot 4 are all configured for downlink for band B. The UE 104 is equipped with memory for 50 MHz bandwidth for band A and band B, respectively. The UE 104 may indicate UE capability to the base station 102 to indicate its DL nominal bandwidth is 100 MHz and 50 MHz for band A and band B, respectively. The UE 104 supports memory sharing from band B to band A, i.e., the UE 104 supports switching its memory from band B to band A. Thus, the nominal DL bandwidth for band A and band B is configured as 100 MHz and 50 MHz, respectively. The total DL bandwidth for band A and band B is configured as 100 MHz. In slot 1, if the sum of bandwidth for PDSCH transmission on band A and bandwidth for PDSCH transmission on band B does not exceed the total DL bandwidth (100 MHz in this example), both PDSCH transmissions can be received by the UE.

In case there are more than one downlink transmissions on more than one downlink carrier on more than one bands, and the sum of bandwidth of the scheduled downlink transmissions exceeds the configured total bandwidth, a prioritization rule is applied to determine which downlink transmission is dropped. This prioritization rule is similar to the prioritization rule discussed above for DL transmissions when there are more than one simultaneous downlink transmissions on more than one downlink carrier on more than one bands and at least one downlink transmission on one carrier on one band exceeds the DL nominal bandwidth for that uplink carrier. Alternatives 1-4 below are the same as Alternatives 3-6 discussed above. A fifth alternative is added. The prioritization rule includes at least one of the following:
Alternative 1: Dropping a downlink transmission on a carrier with a smaller carrier index, and receiving other downlink transmissions that are not dropped.
Alternative 2: Receiving a downlink transmission on a carrier with a smaller carrier index, and dropping other downlink transmissions that are not received.
Alternative 3: Dropping a downlink transmission that finishes or starts the latest, and receiving other downlink transmissions that are not dropped.
Alternative 4: Dropping a downlink transmission that finishes or starts the earliest, and receiving other downlink transmissions that are not dropped.
Alternative 5: Dropping a downlink transmission with a smaller priority, and receiving other downlink transmissions that are not dropped, wherein priority is configured for each carrier or for each band. This alternative allows for flexible configuration of priorities among different carriers.

The UE 104 may indicate the DL nominal bandwidth for each DL carrier and the total bandwidth to the base station 102. The base station 102 may configure DL nominal bandwidth for the downlink carrier that is not larger than the DL nominal bandwidth indicated by the UE 104. The base station 102 may configure DL total bandwidth for the UE 104 that is not larger than the DL total bandwidth indicated by the UE 104.

Turning again to FIG. 9, in slot 1, if the sum of bandwidth for PDSCH transmission on band A and bandwidth for PDSCH transmission on band B exceeds the total DL bandwidth (100 MHz in this example), a prioritization rule is applied to determine which downlink transmission is dropped. For example, if Alternative 1 is applied, if the carrier on band A has a smaller index, then the PDSCH transmission on band A will be dropped.

In accordance with various embodiments, some UE 104 may not support bandwidth boosting. In order to allow UEs that do not support bandwidth boosting to access a carrier, in various embodiments, the Synchronization Signal Block (SSB) may be fully contained within the DL nominal bandwidth, and the Random Access Channel (RACH) resource may be fully contained within the UL nominal bandwidth.

Since PDCCH needs to be monitored by the UE 104 frequently, e.g., in every slot, the PDCCH resources may be fully contained within the DL nominal bandwidth. Since the resource for PUCCH does not require large bandwidth, PUCCH resources may be fully contained within the UL nominal bandwidth. The DL bandwidth boosting is applicable to at least PDSCH. The UL bandwidth boosting is applicable to at least PUSCH.

In various embodiments, at least one of a Synchronization Signal Block (SSB), a Primary Synchronization Signal (PSS), a Secondary Synchronization Signal (SSS), a Physical Broadcast Channel (PBCH), and/or a Physical Downlink Control Channel (PDCCH) are contained within the DL nominal bandwidth. In various embodiments, at least one of a Physical Random Access Channel (PRACH) and/or a Physical Uplink Control Channel (PUCCH) are contained fully within the UL nominal bandwidth.

In accordance with various embodiments, the base station 102 may receive from the UE 104 transmission bandwidth information of the UE 104, and the base station 102 may configure transmission carriers to the UE 104 in accordance with the transmission bandwidth information.

Specifically, the UE 104 may indicate a downlink RF bandwidth to the base station 102. The base station 102 may configure downlink carriers to the UE 104 if the frequency range from the lowest frequency among all the configured downlink carriers to the highest frequency among all the configured downlink carriers is not larger than the RF bandwidth indicated by the UE 104. In other words, the base station 102 cannot configure downlink carriers to the UE 104 if the frequency range from the lowest frequency among all the configured downlink carriers to the highest frequency among all the configured downlink carriers is larger than the UE indicated RF bandwidth.

The UE 104 may indicate a downlink RF bandwidth to the base station 102. Simultaneous transmissions can be transmitted on downlink carriers to the UE 104 if the frequency range from the lowest frequency among all the simultaneous transmissions to the highest frequency among all the simultaneous transmissions is not larger than the RF bandwidth indicated by the UE 104. In other words, simultaneous transmissions cannot be transmitted on downlink carriers to the UE 104 if the frequency range from the lowest frequency among all the simultaneous transmissions to the highest frequency among all the simultaneous transmissions is larger than the RF bandwidth indicated by the UE 104.

The UE 104 may indicate an uplink RF bandwidth to the base station 102. The base station 102 may configure uplink carriers to the UE 104 if the frequency range from the lowest frequency among all the configured uplink carriers to the highest frequency among all the configured uplink carriers is not larger than the RF bandwidth indicated by the UE 104. In other words, the base station 102 cannot configure uplink carriers to the UE 104 if the frequency range from the lowest frequency among all the configured uplink carriers to the highest frequency among all the configured uplink carriers is larger than the RF bandwidth indicated by the UE 104.

The UE may indicate an uplink RF bandwidth to the base station 102. Simultaneous transmissions can be transmitted on uplink carriers from the UE 104 if the frequency range from the lowest frequency among all the simultaneous transmissions to the highest frequency among all the simultaneous transmissions is not larger than the RF bandwidth indicated by the UE 104. In other words, simultaneous transmissions cannot be transmitted on uplink carriers to the UE 104 if the frequency range from the lowest frequency among all the simultaneous transmissions to the highest frequency among all the simultaneous transmissions is larger than the RF bandwidth indicated by the UE.

For example, the frequency ranges for band n12, n13, n14, n18, and n20 are listed in the following table. If the UE 104 indicates a downlink RF bandwidth as 100 MHz, then one DL carrier from band n12 spanning from 729 MHz-746 MHz and another DL carrier from band n13 spanning from 746 MHz-756 MHz can be configured to the UE 104 since the lowest frequency among all the configured downlink carriers to the highest frequency among all the configured downlink carriers is 27 MHz, which is smaller than the UE's indicated RF bandwidth. However, one DL carrier from band n12 spanning from 729 MHz-746 MHz and another DL carrier from band n18 spanning from 860 MHz-875 MHz cannot be configured to the UE 104 since the lowest frequency among all the configured downlink carriers to the highest frequency among all the configured downlink carriers is 146 MHz, which is larger than the UE's indicated RF bandwidth.

| | Uplink (UL) operating | Downlink (DL) operating | |
|---|---|---|---|
| NR | band BS receive/ | band BS transmit/ | |
| operating | UE transmit | UE receive | Duplex |
| band | F_{UL}_{_{—}}_{low}-F_{UL}_{_{—}}_{high} | F_{DL}_{_{—}}_{low}-F_{DL}_{_{—}}_{high} | Mode |
| n12 | 699 MHz-716 MHz | 729 MHz-746 MHz | FDD |
| n13 | 777 MHz-787 MHz | 746 MHz-756 MHz | FDD |
| n14 | 788 MHz-798 MHz | 758 MHz-768 MHz | FDD |
| n18 | 815 MHz-830 MHz | 860 MHz-875 MHz | FDD |
| n20 | 832 MHz-862 MHz | 791 MHz-821 MHz | FDD |

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation/example/approach” as used herein does not necessarily refer to the same embodiment and the phrase “in another embodiment/implementation/example/approach” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

I/We claim:

1. A method performed by a wireless terminal device for handling transmissions, the wireless terminal device being configured with P transmission carriers on a plurality of bands, where P is an integer and P is larger than 1, the method comprising:
configuring a nominal bandwidth and a boost bandwidth for each transmission carrier on the plurality of bands, wherein the boost bandwidth is larger than the nominal bandwidth, and the boost bandwidth contains all Resource Elements (REs) or Resource Blocks (RBs) of the nominal bandwidth; and
determining whether a switching period for memory switching is needed based on a bandwidth applied for transmissions on the transmission carriers.

2. The method according to claim 1 wherein
the P transmission carriers are P downlink (DL) transmission carriers, and the transmissions are downlink transmissions,
wherein the configuring comprises configuring a DL nominal bandwidth and a DL boost bandwidth for each downlink carrier of each band, and
wherein the DL boost bandwidth is larger than the DL nominal bandwidth, and
wherein the DL boost bandwidth contains all REs or RBs of the DL nominal bandwidth.

3. The method according to claim 2, further comprising:
receiving downlink transmissions on at least two of the P downlink carriers simultaneously when each downlink transmission on each carrier occupies a frequency bandwidth no larger than the DL nominal bandwidth configured for each DL carrier.

4. The method according to claim 2, further comprising:
applying a prioritization rule to determine which downlink transmission to drop in response to there being more than one simultaneous downlink transmissions on more than one downlink carrier on more than one band, and at least one downlink transmission on one carrier on one band exceeding the DL nominal bandwidth for that downlink carrier.

5. The method according to claim 2, further comprising:
receiving downlink transmission that is equal to or smaller than the DL boost bandwidth in case of bandwidth boosting.

6. The method according to claim 2, further comprising:
applying, by the wireless terminal device, the DL nominal bandwidth in response to at least one of the following:
a downlink transmission is scheduled on one downlink carrier that occupies frequency bandwidth not larger than the configured DL nominal bandwidth for the carrier,
a downlink transmission on is scheduled on one downlink carrier that does not occupy a frequency resource outside the DL nominal bandwidth for the carrier, or
simultaneous downlink transmissions are transmitted on more than one band; or
applying, by the wireless terminal device, the DL boost bandwidth in response to at least one of the following:
a downlink transmission is scheduled on one downlink carrier that occupies frequency bandwidth larger than the configured DL nominal bandwidth for the carrier,
a downlink transmission is scheduled on one downlink carrier that occupies frequency resource outside the DL nominal bandwidth for the carrier, or
simultaneous downlink transmissions are transmitted on only one band.

7. The method according to claim 2, further comprising:
determining that the switching period is needed in response to determining that the wireless terminal device is to receive a downlink transmission on one downlink carrier on one band and the downlink transmission occupies a frequency bandwidth larger than the configured DL nominal bandwidth, and in response to a preceding downlink transmission being on another downlink carrier on another band; or
determining that the switching period is needed in response to determining that the wireless terminal device is to receive a downlink transmission on one downlink carrier on one band and the downlink transmission occupies a frequency resource outside the DL nominal bandwidth, and in response to a preceding downlink transmission being on another downlink carrier on another band; or
determining that the switching period is needed in response to determining that the wireless terminal device is to receive a downlink transmission on one downlink carrier on one band and a preceding downlink transmission is on another downlink carrier on another band, and the preceding downlink transmission occupies a frequency bandwidth larger than the configured DL nominal bandwidth; or
determining that the switching period is needed in response to determining that the wireless terminal device is to receive a downlink transmission on one downlink carrier on one band and a preceding downlink transmission is on another downlink carrier on another band, and the preceding downlink transmission occupies a frequency resource outside the DL nominal bandwidth; or
determining that the switching period is needed in response to determining that the wireless terminal device is to receive a downlink transmission on one downlink carrier on one band and the downlink transmission occupies frequency bandwidth larger than the configured DL nominal bandwidth, and a preceding downlink transmission is on a downlink carrier on a same band and the wireless terminal device is under an operation state in which downlink transmission occupying frequency bandwidth larger than the configured DL nominal bandwidth cannot be supported in the same band; or
determining that the switching period is needed in response to determining that the wireless terminal device is to receive a downlink transmission on one downlink carrier on one band and the downlink transmission occupies a frequency resource outside the DL nominal bandwidth, and a preceding downlink transmission is on a downlink carrier on a same band and the wireless terminal device is under an operation state in which downlink transmission occupying frequency resources outside the DL nominal bandwidth cannot be supported in the same band; or
determining that the switching period is needed in response to determining that the wireless terminal device is to receive a downlink transmission on one downlink carrier on one band, and a preceding downlink transmission is on another downlink carrier on another band and the wireless terminal device is under an operation state in which downlink transmission occupying a frequency bandwidth larger than the configured DL nominal bandwidth can be supported in a same other band; or
determining that the switching period is needed in response to determining that the wireless terminal device is to receive a downlink transmission on one downlink carrier on one band, and a preceding downlink transmission is on another downlink carrier on another band and the wireless terminal device is under an operation state in which downlink transmission occupying a frequency resource outside the DL nominal bandwidth can be supported in a same other band.

8. The method according to claim 2,
wherein each of the P downlink carriers is configured with a DL nominal bandwidth, and wherein each of the DL nominal bandwidths configured for the P downlink carriers contains Nᵢ Resource Elements (Res) or Resource Blocks (RBs) in frequency domain, where Nᵢ is an integer larger than 0, and i is an index of downlink carriers, where 1≤i≤P, wherein the wireless terminal device is configured with a total bandwidth for the P downlink carriers containing M REs or RBs in frequency domain, wherein M is an integer larger than 0,
wherein M satisfies the following conditions:
$$M \geq {N}_{i} , 1 \leq i \leq P , and$$
$$M \leq {\sum }_{i = 1}^{P} {N}_{i} . , and$$
wherein the method further comprises:
receiving, by the wireless terminal device, downlink transmissions on multiple carriers on multiple bands simultaneously when a sum of bandwidth of the downlink transmissions does not exceed the configured total bandwidth; or
applying a prioritization rule to determine which downlink transmission to drop in response to there being more than one simultaneous downlink transmissions on more than one downlink carrier on more than one band, and a sum of bandwidth of the downlink transmissions exceeds the configured total bandwidth.

9. The method according to claim 2,
wherein, during the switching period, at least one of the following is satisfied:
the wireless terminal device is not expected to receive any downlink transmissions;
the wireless terminal device drops downlink transmission on bands involved in the memory switching; or
a wireless access network node avoids scheduling downlink transmission that is to be transmitted during the switching period.

10. The method according to claim 2,
wherein the switching period allows for memory switching of a first memory allocated for transmissions on a first band of the P transmission carriers to being allocated for transmissions on a second band of the P transmission carriers.

11. The method according to claim 1 wherein
the P transmission carriers are P uplink (UL) transmission carriers, and the transmissions are uplink transmissions,
wherein the configuring comprises configuring a UL nominal bandwidth and a UL boost bandwidth for each uplink carrier of each band, and
wherein the UL boost bandwidth is larger than the UL nominal bandwidth, and
wherein the UL boost bandwidth contains all REs or RBs of the UL nominal bandwidth.

12. The method according to claim 11, further comprising:
transmitting uplink transmissions on at least two of the P UL carriers simultaneously when each UL transmission on each UL carrier occupies a frequency bandwidth no larger than the UL nominal bandwidth configured for each UL carrier; or
applying a prioritization rule to determine which UL transmission to drop in response to there being more than one simultaneous UL transmissions on more than one UL carrier on more than one band, and at least one UL transmission on one carrier on one band exceeding the UL nominal bandwidth for that UL carrier.

13. The method according to claim 11, further comprising:
transmitting UL transmission that is equal to or smaller than the UL boost bandwidth in case of bandwidth boosting.

14. The method according to claim 11, further comprising:
applying, by the wireless terminal device, the UL nominal bandwidth in response to at least one of the following:
a UL transmission is scheduled on one UL carrier that occupies frequency bandwidth not larger than the configured UL nominal bandwidth for the carrier,
a UL transmission is scheduled on one UL carrier that does not occupy a frequency resource outside the UL nominal bandwidth for the carrier, or
simultaneous UL transmissions are transmitted on more than one band or
applying, by the wireless terminal device, the UL boost bandwidth in response to at least one of the following:
a UL transmission is scheduled on one UL carrier that occupies frequency bandwidth larger than the configured UL nominal bandwidth for the carrier,
a UL transmission is scheduled on one UL carrier that occupies frequency resource outside the UL nominal bandwidth for the carrier, or
simultaneous UL transmissions are transmitted on only one band.

15. The method according to claim 11, further comprising:
determining that the switching period is needed in response to determining that the wireless terminal device is to transmit a UL transmission on one UL carrier on one band and the UL transmission occupies a frequency bandwidth larger than the configured UL nominal bandwidth, and in response to a preceding UL transmission being on another UL carrier on another band; or
determining that the switching period is needed in response to determining that the wireless terminal device is to transmit a UL transmission on one UL carrier on one band and the UL transmission occupies a frequency resource outside the UL nominal bandwidth, and in response to a preceding UL transmission being on another UL carrier on another band; or
determining that the switching period is needed in response to determining that the wireless terminal device is to transmit a UL transmission on one UL carrier on one band and a preceding UL transmission is on another UL carrier on another band, and the preceding UL transmission occupies a frequency bandwidth larger than the configured UL nominal bandwidth; or
determining that the switching period is needed in response to determining that the wireless terminal device is to transmit a UL transmission on one UL carrier on one band and a preceding UL transmission is on another UL carrier on another band, and the preceding UL transmission occupies a frequency resource outside the UL nominal bandwidth; or
determining that the switching period is needed in response to determining that the wireless terminal device is to transmit a UL transmission on one UL carrier on one band and the UL transmission occupies frequency bandwidth larger than the configured UL nominal bandwidth, and a preceding UL transmission is on a UL carrier on a same band and the wireless terminal device is under an operation state in which UL transmission occupying frequency bandwidth larger than the configured UL nominal bandwidth cannot be supported in the same band; or
determining that the switching period is needed in response to determining that the wireless terminal device is to transmit a UL transmission on one UL carrier on one band and the UL transmission occupies a frequency resource outside the UL nominal bandwidth, and a preceding UL transmission is on a UL carrier on a same band and the wireless terminal device is under an operation state in which UL transmission occupying frequency resources outside the UL nominal bandwidth cannot be supported in the same band; or
determining that the switching period is needed in response to determining that the wireless terminal device is to transmit a UL transmission on one UL carrier on one band, and a preceding UL transmission is on another UL carrier on another band and the wireless terminal device is under an operation state in which UL transmission occupying a frequency bandwidth larger than the configured UL nominal bandwidth can be supported in a same other band; or
determining that the switching period is needed in response to determining that the wireless terminal device is to transmit a UL transmission on one UL carrier on one band, and a preceding UL transmission is on another UL carrier on another band and the wireless terminal device is under an operation state in which UL transmission occupying a frequency resource outside the UL nominal bandwidth can be supported in a same other band.

16. The method according to claim 11,
wherein each of the P UL carriers is configured with a UL nominal bandwidth, and wherein each of the UL nominal bandwidths configured for the P UL carriers contains Nᵢ Resource Elements (Res) or Resource Blocks (RBs) in frequency domain, where Nᵢ is an integer larger than 0, and i is an index of UL carriers, where 1≤i≤P, wherein the wireless terminal device is configured with a total bandwidth for the P UL carriers containing M REs or RBs in frequency domain, wherein M is an integer larger than 0,
wherein M satisfies the following conditions:
$$M \geq {N}_{i} , 1 \leq i \leq P , and$$
$$M \leq {\sum }_{i = 1}^{P} {N}_{i} . , and$$
wherein the method further comprises:
transmitting, by the wireless terminal device, UL transmissions on multiple carriers on multiple bands simultaneously when a sum of bandwidth of the UL transmissions does not exceed the configured total bandwidth; or
applying a prioritization rule to determine which UL transmission to drop in response to there being more than one simultaneous UL transmissions on more than one UL carrier on more than one band, and a sum of bandwidth of the UL transmissions exceeds the configured total bandwidth.

17. The method according to claim 11,
wherein, during the switching period, at least one of the following is satisfied:
the wireless terminal device is not expected to transmit any UL transmissions;
the wireless terminal device drops UL transmission on bands involved in the memory switching; or
a wireless access network node avoids scheduling UL transmission that is to be transmitted during the switching period.

18. The method according to claim 11,
wherein the switching period allows for memory switching of a first memory allocated for transmissions on a first band of the P transmission carriers to being allocated for transmissions on a second band of the P transmission carriers.

19. An apparatus for wireless communication, comprising:
a memory; and
one or more processors, the one or more processors configured to:
configure a nominal bandwidth and a boost bandwidth for each transmission carrier of P transmission carriers on a plurality of bands, wherein the boost bandwidth is larger than the nominal bandwidth, and the boost bandwidth contains all Resource Elements (REs) or Resource Blocks (RBs) of the nominal bandwidth; and
determine whether a switching period for memory switching is needed based on a bandwidth applied for transmissions on the P transmission carriers, where P is an integer and P is larger than 1.

20. The apparatus of claim 19, wherein the P transmission carriers are one of:
P downlink (DL) transmission carriers, and the transmissions are DL transmissions, or
P uplink (UL) transmission carriers, and the transmissions are UL transmissions.
